(19) United States
(12) Patent Application Publication
(10) Pub. No.: US 2016/0147499 A1
(43) Pub. Date: May 26, 2016

(54) METHOD OF EXCHANGING INFORMATION WITH EXTERNAL DEVICE AND ELECTRONIC DEVICE FOR THE SAME

(71) Applicant: Samsung Electronics Co., Ltd, Gyeonggi-do (KR)

(72) Inventor: Dae-Young Ryu, Gyeonggi-do (KR)

(21) Appl. No.: 14/950,948

(22) Filed: Nov. 24, 2015

(30) Foreign Application Priority Data
Nov. 26, 2014 (KR) 10-2014-0166204

(51) Int. Cl. G06F 3/14; G06F 3/0484; G06F 3/0482

(52) U.S. Cl. CPC G06F 3/1454; G06F 3/0482; G06F 3/04842

(57) ABSTRACT

Disclosed is a method of exchanging information with an external device. The method includes: receiving information about one or more applications installed in the external device from the connected external device, listing and displaying a GUI corresponding to the application on a screen according to the information about the application, transmitting a control request for the application corresponding to a user input for the GUI to the external device, and receiving control command information according to the control request from the external device and applying a control command.

### CROSS-REFERENCE TO RELATED APPLICATION(S) AND CLAIM OF PRIORITY

The present application is related to and claims the priority under 35 U.S.C. §119(a) to Korean Application Serial No. 10-2014-0166204, which was filed in the Korean Intellectual Property Office on Nov. 26, 2014, the entire content of which is hereby incorporated by reference.

### TECHNICAL FIELD

The present application relates to a method of exchanging information between electronic devices, and an electronic device for the same.

### BACKGROUND

Recently, an electronic device, such as a smart phone or a tablet PC, has been used to link with an external device, such as a computer or an In-Vehicle Infotainment (IVI). For example, a technique for controlling, by a computer, a function of a mobile device by connecting the computer to the mobile device in the related art has been developed, and this technique may transmit an execution image of the mobile device to a screen of the computer as it is and allow the execution image to be displayed. According to the related art, the electronic devices, which are linked with each other, may share and use various functions (for example, applications) together.

### SUMMARY

In the technique for controlling a function of a mobile device by connecting the mobile device to the computer using a computer, the computer only displays a screen image of the mobile device on a screen thereof, but fails to provide a new screen image for enabling a user to conveniently operate applications installed in the mobile device or a function of the mobile device through the computer.

To address the above-discussed deficiencies, it is a primary object to provide a method of exchanging information with an external device when electronic devices are connected with each other and used, and an electronic device for the same.

An exemplary embodiment of the present disclosure provides a method of exchanging information with an external device, including: receiving information about one or more applications installed in the external device from the connected external device; displaying a Graphic User Interface (GUI) corresponding to the application on a screen according to the information about the application; transmitting a control request for the application corresponding to a user input for the GUI to the external device; and receiving control command information according to the control request from the external device and applying a control command.

Another exemplary embodiment of the present disclosure provides an electronic device, including: a communication module; an input unit that receives an input of a user; a display unit that displays an execution image and an operation state of an application program of the electronic device, and a menu state; and a controller that receives information about one or more applications installed in an external device from the external device connected through the communication module, list a GUI corresponding to the application according to the information about the application and displaying the listed GUI on the display unit, transmit a control request for the application to the external device through the communication module according to a user input for the GUI through the input unit, and receive control command information according to the control request from the external device through the communication module and apply a control command.

According to various exemplary embodiments of the present disclosure, the method of exchanging information with an external device and the electronic device for the same provides a screen of the computer with a new image, through which a user can conveniently operate applications installed in a mobile device or a function of a mobile device in a computer when electronic devices are connected and used.

Further, according to various exemplary embodiments of the present disclosure, the method of exchanging information with an external device and the electronic device for the same displays image information about an execution state of an application of a mobile device or a command list on a screen of a computer, and enables a user to operate an application installed in the mobile device when electronic devices (for example, a mobile device or a computer) are connected and used.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating an exchange of information between an electronic device and an external device according to an exemplary embodiment of the present disclosure;

FIG. 2 is a block diagram of an electronic device for exchanging information with an external device according to an exemplary embodiment of the present disclosure;

FIG. 3 is a diagram illustrating a result of execution of an application of an external device by an electronic device according to an exemplary embodiment of the present disclosure;

FIG. 4 is a diagram illustrating an operation of exchanging information with an external device by an electronic device according to an exemplary embodiment of the present disclosure;

FIG. 5 is a flowchart illustrating an operation of exchanging information with an external device by an electronic device according to an exemplary embodiment of the present disclosure;

FIG. 6 is a flowchart illustrating an operation of acquiring and updating information about an external device by an electronic device according to an exemplary embodiment of the present disclosure;

FIG. 7 is a flowchart illustrating an operation of acquiring and updating information about an external device by an electronic device according to another exemplary embodiment of the present disclosure;

FIG. 8 is a flowchart illustrating an operation of exchanging information with an external device by an electronic device in order to change a setting of an application in the electronic device according to an exemplary embodiment of the present disclosure;

FIG. 9 is a flowchart illustrating an operation of exchanging information with an external device by an electronic device in order to change a setting of an application according to another exemplary embodiment of the present disclosure;

FIG. 10 is a flowchart illustrating an operation of exchanging information with an external device by an electronic device in order to change a setting of an application in an electronic device according to yet another exemplary embodiment of the present disclosure;

FIG. 11 is a flowchart illustrating an operation of exchanging information with an external device by an electronic device in order to change a setting of an application in the electronic device and/or the external device according to an exemplary embodiment of the present disclosure;

FIG. 12 is a diagram illustrating an operation of exchanging information with an external device by the electronic device in order to change a setting of an application in the electronic device and/or the external device according to an exemplary embodiment of the present disclosure;

FIG. 13 is a flowchart illustrating an operation of displaying a command list of an application in an electronic device according to an exemplary embodiment of the present disclosure;

FIGS. 14A and 14B are diagrams illustrating graphic user interfaces of applications or a command list of an application according to an exemplary embodiment of the present disclosure;

FIGS. 15A and 15B are diagrams illustrating an operation of storing, by an electronic device, information received from an external device and utilizing the stored information according to an exemplary embodiment of the present disclosure;

FIG. 16 is a program code for exchanging information with an external device by an electronic device according to an exemplary embodiment of the present disclosure; and

FIGS. 17A, 17B and 17C are program codes for exchanging information with an external device by an electronic device according to another exemplary embodiment of the present disclosure.

### DETAILED DESCRIPTION

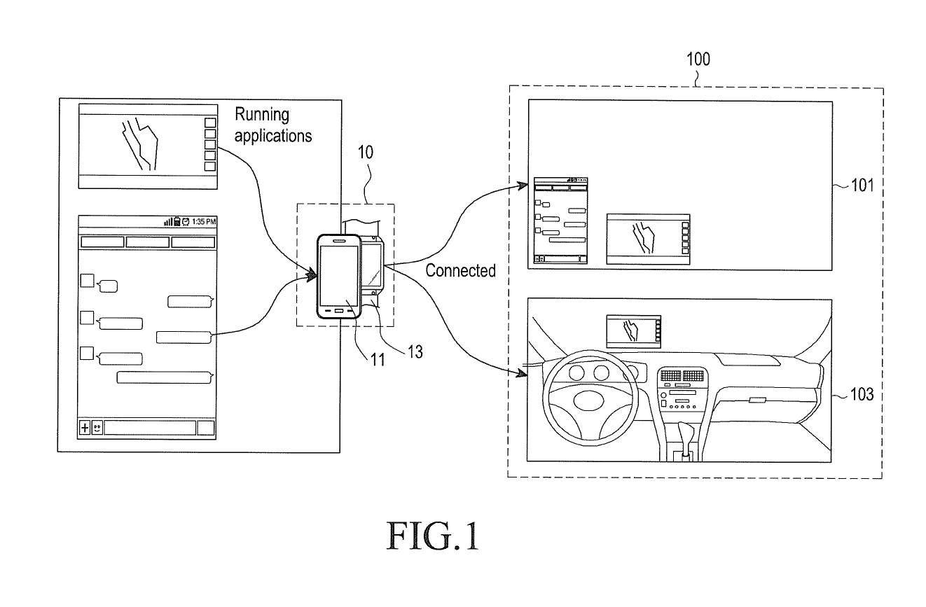

FIGS. 1 through 17C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device or electronic system. Various embodiments of the present disclosure will now be described more fully in conjunction with the accompanying drawings. The present disclosure may have various embodiments, and modifications and changes may be made therein. Therefore, the present disclosure will be described in detail with reference to particular embodiments shown in the accompanying drawings. However, it should be understood that there is no intent to limit various embodiments of the present disclosure to the particular embodiments disclosed, but the present disclosure should be construed to cover all modifications, equivalents, and alternatives falling within the spirit and scope of the various embodiments of disclosure. In the description of the drawings, identical or similar reference numerals are used to designate identical or similar elements.

Hereinafter, the terms “include” or “may include”, which may be used in various embodiments of the present disclosure, refer to the presence of disclosed functions, operations or elements, and do not restrict the addition of one or more functions, operations or elements. Further, as used in various embodiments of the present disclosure, the terms “include”, “have” and their conjugates can be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A and/or B” “at least one of A and B” can include A, can include B, or can include both A and B.

The expressions such as “first,” “second,” or the like used in various embodiments of the present disclosure modify various component elements in the various embodiments but may not limit corresponding component elements. For example, the above expressions do not limit the sequence and/or importance of the corresponding elements. The expressions can be used to distinguish a component element from another component element. For example, a first user device and a second user device indicate different user devices although both of them are user devices. For example, a first constituent element may be termed a second constituent element, and likewise a second constituent element may also be termed a first constituent element without departing from the scope of various embodiments of the present disclosure.

It should be noted that if it is described that one component element is “coupled” or “connected” to another component element, the first component element may be directly coupled or connected to the second component, and a third component element may be “coupled” or “connected’ between the first and second component elements. Conversely, when one component element is “directly coupled” or “directly connected” to another component element, it may be construed that a third component element does not exist between the first component element and the second component element.

The terms as used in various embodiments of the present disclosure are merely for the purpose of describing particular embodiments and are not intended to limit the various embodiments of the present disclosure. As used herein, the singular forms are intended to include the plural forms as well, unless the context clearly indicates otherwise.

Unless defined otherwise, all terms used herein, including technical terms and scientific terms, have the same meaning as commonly understood by a person of ordinary skill in the art to which various embodiments of the present disclosure pertain. Such terms as those defined in a generally used dictionary are to be interpreted to have the meanings equal to the contextual meanings in the relevant field of art, and are not to be interpreted to have ideal or excessively formal meanings unless clearly defined in various embodiments of the present disclosure.

An electronic device according to embodiments of the present disclosure is a device including a communication function. For example, the electronic devices includes at least one of smart phones, tablet personal computers (PCs), mobile phones, video phones, e-book readers, desktop PCs, laptop PCs, netbook computers, personal digital assistants (PDAs), portable multimedia players (PMPs), MP3 players, mobile medical devices, cameras, wearable devices {e.g., head-mounted-devices (HMDs) such as electronic glasses}, electronic clothes, electronic bracelets, electronic necklaces, electronic appcessories, electronic tattoos, or smart watches.

According to some embodiments, the electronic device is a smart home appliance with a communication function. The smart home appliance as an example of the electronic device includes at least one of, for example, a television, a Digital Video Disk (DVD) player, an audio system, a refrigerator, an air conditioner, a vacuum cleaner, an oven, a microwave oven, a washing machine, an air cleaner, a set-top box, a TV box (e.g., SAMSUNG HOMESYNC®, APPLE TV®, or GOOGLE TV®), a game console, an electronic dictionary, an electronic key, a camcorder, and an electronic picture frame.

According to some embodiments, the electronic device includes at least one of various medical appliances (for example, magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (such as, ship navigation equipment and a gyrocompass), avionics, security equipment, a vehicle head unit, an industrial or home robot, an automatic teller machine (ATM) of a banking system, and a point of sales (POS) of a shop.

According to some embodiments, the electronic device includes at least one of a part of furniture or a building/structure having a communication function, an electronic board, an electronic signature receiving device, a projector, and various kinds of measuring instruments (such as, a water meter, an electric meter, a gas meter, a radio wave meter, and the like). The electronic device according to various embodiments of the present disclosure can be a combination of one or more of the aforementioned various devices. Further, the electronic device according to various embodiments of the present disclosure is a flexible device. Further, it will be apparent to those skilled in the art that the electronic device according to various embodiments of the present disclosure is not limited to the aforementioned devices.

The term “user” used in various embodiments refers to a person who uses an electronic device or a device (for example, an artificial intelligence electronic device) that uses an electronic device.

FIG. 1 is a diagram illustrating an exchange of information between an electronic device and an external device according to an exemplary embodiment of the present disclosure. Referring to FIG. 1, according to an operation of exchanging, by an electronic device, information with an external device according to an exemplary embodiment of the present disclosure, an electronic device 100, such as a computer 101 or an In-Vehicle Infotainment (IVI) 103, is connected with an external device 10, such as a smart phone 11 or a smart watch 13, and used.

For example, the electronic device 100 and the external device 10 can be in a connection state, for example, in a pairing state. For example, a protocol (for example, TCP/IP) can be stored in advance in order to exchange data between the electronic device 100 and the external device 10, and the electronic device 100 and the external device 10 can be connected with each other through, for example, WiFi communication, USB communication, HDMI communication, Ethernet communication, or BLUETOOTH® communication. When the electronic device 100 and the external device 10 are in the connection state, the electronic device 100 receives information about an application installed in the external device 10 and/or system information about the external device 10 from the external device 10, and displays the information about the applications installed in the external device 10 and/or the system information about the external device 10 on a display unit of the electronic device 100. The system information can variously include, for example, battery capacity of the external device 10, a memory use amount of the external device 10, and/or the total memory capacity of the external device 10, or a combination thereof.

Further, for example, the electronic device 100 receives the information about the application installed in the external device 10 or the system information about the external device 10 from the external device 10, and executes a specific application of the external device 10 in the electronic device 100.

Further, for example, the electronic device 100 receives the information about the application installed in the external device 10 and/or the system information about the external device 10 from the external device 10, and displays information related to the application running in the external device 10 on the display unit of the electronic device 100. Further, the information about the application may contain, for example, identification information about the application and/or information indicating that an application is currently running in the external device 10.

According to various exemplary embodiments of the present disclosure, the electronic device and the external device can be the same or different electron devices, such as a smart phone, a smart watch, a tablet PC, a computer, or an IVI.

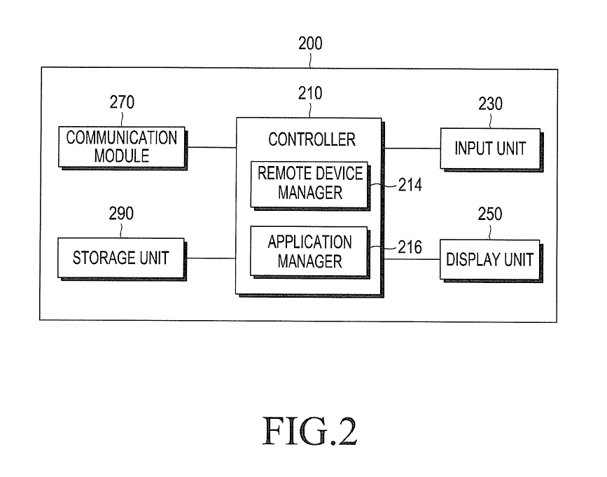

FIG. 2 is a block diagram of an electronic device for exchanging information with an external device according to an exemplary embodiment of the present disclosure. Referring to FIG. 2, an electronic device 200 includes a controller 210, an input unit 230, a display unit 250, a communication module 270, and a storage unit 290.

The input unit 230 receives a user input, and includes, for example, a touch panel (not shown), a (digital) pen sensor (not shown), a key (not shown), or an ultrasonic input device (not shown). The touch panel adopts at least one of, for example, a capacitive method, a resistive method, an infrared ray method, and an ultrasonic wave method. Also, the touch panel further includes a control circuit. The touch panel further includes a tactile layer to provide a tactile response to a user. The (digital) pen sensor can be, for example, a part of the touch panel or include a separate sheet for recognition. The key includes, for example, a physical button, an optical key, or a keypad. The ultrasonic input device detects ultrasonic waves generated by an input tool through a microphone (not shown), and confirms data corresponding to the detected ultrasonic waves.

The display unit 250 displays execution images, operation states, or menu states of various application programs, and includes a panel (not shown), a hologram device (not shown), or a projector (not shown). The display panel can be, for example, flexible, transparent, or wearable. The panel can be configured as one module with a touch panel. The hologram device can show a 3D image in the air by using interference of light. A projector displays an image by projecting light onto a screen. The screen can be positioned, for example, in an internal side or on external side of the electronic device 200. According to one exemplary embodiment, the display unit 250 further includes a control circuit for controlling the panel, the hologram device, or the projector.

The communication module 270 establishes communication between, for example, the electronic device 200 and an external device (for example, a first external device (not shown), a second external device (not shown), or a server (not shown). For example, the communication module 270 can be connected to a network (not shown) through wireless communication or wired communication and communicate with the external device (for example, the second external device) or the server.

The wireless communication uses at least one of Long-Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM) as, for example, a cellular communication protocol. Further, the wireless communication can include short range communication (not shown). The short range communication includes at least one of, for example, Wireless Fidelity (WiFi), Bluetooth, Near Field Communication (NFC), and a Global Positioning System (GPS). The wire communication includes at least one of, for example, a Universal Serial Bus (USB), a High Definition Multimedia Interface (HDMI), Recommended Standard-232 (RS-232), an Inter-Integrated Circuit (I2C), an Inter-Integrated Circuit Sound (I2S), Peripheral component interconnect (PCI), a Universal Asynchronous Receiver Transmitter (UART), and a Plain Old Telephone Service (POTS). The network includes at least one of communication network, for example, a computer network (for example, a LAN or a WAN), the Internet, and a telephone network. The storage unit 290 stores signals or data input/output in accordance with operations of the input unit 230, the display unit 250, and the communication unit 270 according to a control of the controller 210. The storage unit 290 includes a volatile and/or nonvolatile memory. The storage unit 290 stores, for example, a command or data related to at least one another element of the electronic device 200. According to an exemplary embodiment, the storage unit 290 stores software and/or a program (not shown). The program includes, for example, a kernel (not shown), middleware (not shown), an application programming interface (API) (not shown), and/or an application program (or “application”) (not shown). At least a part of the kernel, the middleware, or the API can be referred to as an Operating System (OS).

The kernel controls or manages system resources (for example, the controller 210 or the storage unit 290) used for executing an operation or a function implemented in other programs (for example, the middleware, the API, or the application program). Also, the middleware, the API, or the application program accesses a separate element of the electronic device 200, so that the kernel can provide an interface capable of controlling or managing the system resources.

The middleware performs an intermediary function so as to enable, for example, the API or the application program to communicate and transmits and receives data with the kernel.

Further, the middleware processes one or more work requests received from the application program according to a priority. For example, the middleware can assign a priority for using the system resource (for example, the controller 210 or the storage unit 290) of the electronic device 200 to at least one of the application programs. For example, the middleware can perform scheduling or load balancing on one or more work requests by processing one or more work requests according to the priority assigned to at least one of the application programs.

The API is an interface for allowing an application to control a function provided from the kernel or the middleware, and can include at least one interface or function (for example, a command) for, for example, file control, window control, image processing, or character control.

The controller 210 includes one or more among a Central Processing Unit (CPU), an Application Processor (AP), and a Communication Processor (CP). The controller 210 executes calculation or data processing for the control and/or the communication of one or more other elements (for example, the input unit 230, the display unit 250, the communication module 270, and/or the storage unit 290) of the electronic device 200.

According to the exemplary embodiment of the present disclosure, the controller 210 includes a remote device manager 214 and an application manager 216.

The remote device manager 214 transmits information to an external device or receives information from an external device through the communication module 270. Further, the remote device manager 214 manages a connection with each external device connected with the electronic device 200.

The application manager 216 manages a Graphic User Interface (GUI) of an application for each external device.

According to the exemplary embodiment of the present disclosure, the remote device manager 214 receives information about one or more application installed in an external device from the external device through the communication module 270. Further, the remote device manager 214 generates a control so that GUIs corresponding to the application is listed and displayed on the display unit 250 according to the received information about the application. Further, the application manager 216 stores the information about the application received in the remote device manager 214 in the storage unit 290. Further, according to a user manipulation for the GUI through the input unit 230, the remote device manager 214 generates a control so that a control request for the application is transmitted to the external device through the communication module 270, control reception of control command information according to the control request from the external device through the communication module 270, and applies a control command to the electronic device.

In the meantime, the remote device manager 214 or the application manager 216 are separated and implemented as the respective element of the controller 210 as illustrated in FIG. 2, or the remote device manager 214 and the application manager 216 can be integrated and implemented as one element of the controller 210. Further, the remote device manager 214 or the application manager 216 can be included in the controller 210 as illustrated in FIG. 2, or can be implemented as an independent element of the electronic device 200 that is separated from the controller 210.

Further, according to the exemplary embodiment, the information about the application and/or the control request for the application is data in an Extensible Markup Language (XML) form.

In the meantime, the configuration of the external device can be the same as the configuration of the block diagram of the electronic device 200 of FIG. 2, or the configuration of the block diagram of the electronic device 200 of FIG. 2, with some elements are added or deleted.

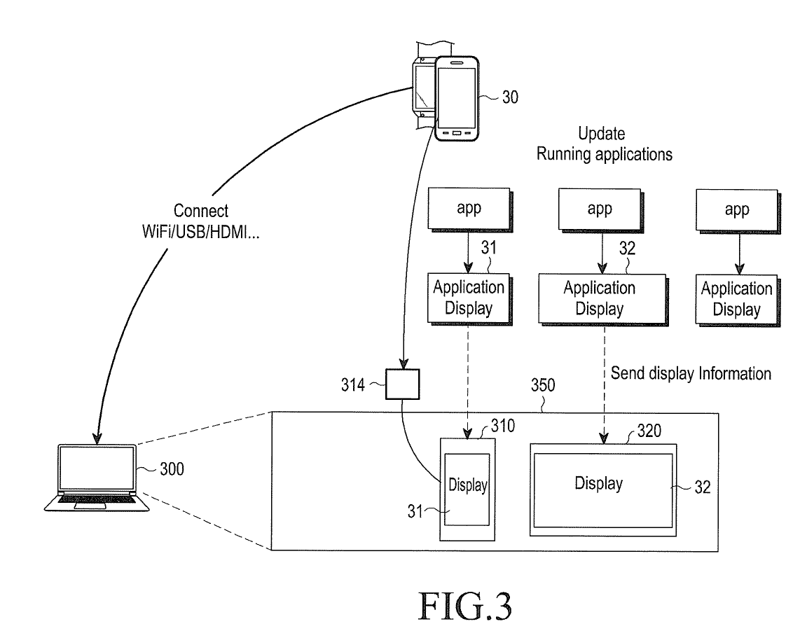

FIG. 3 is a diagram illustrating a result of execution of an application of an external device by an electronic device according to an exemplary embodiment of the present disclosure. Referring to FIG. 3, an electronic device 300 and an external device 30 are connected and communicate with each other through wireless communication or wire communication, for example, WiFi, a USB, or a HDMI cable. Further, when the external device 30 is connected to the electronic device 300, and then an application of the external device 30 is executed in the electronic device 300 according to a user manipulation, a remote device manager 314 of the electronic device 300 displays execution images 310 and 320 having different sizes from those of execution images 31 and 32 displayed when the external device 30 executes the applications on a display unit 350 of the electronic device 300. Further, the execution images of the applications displayed on the display unit 350 of the electronic device 300 can be set to be displayed with different sizes for each application, and set to be displayed with the same size.

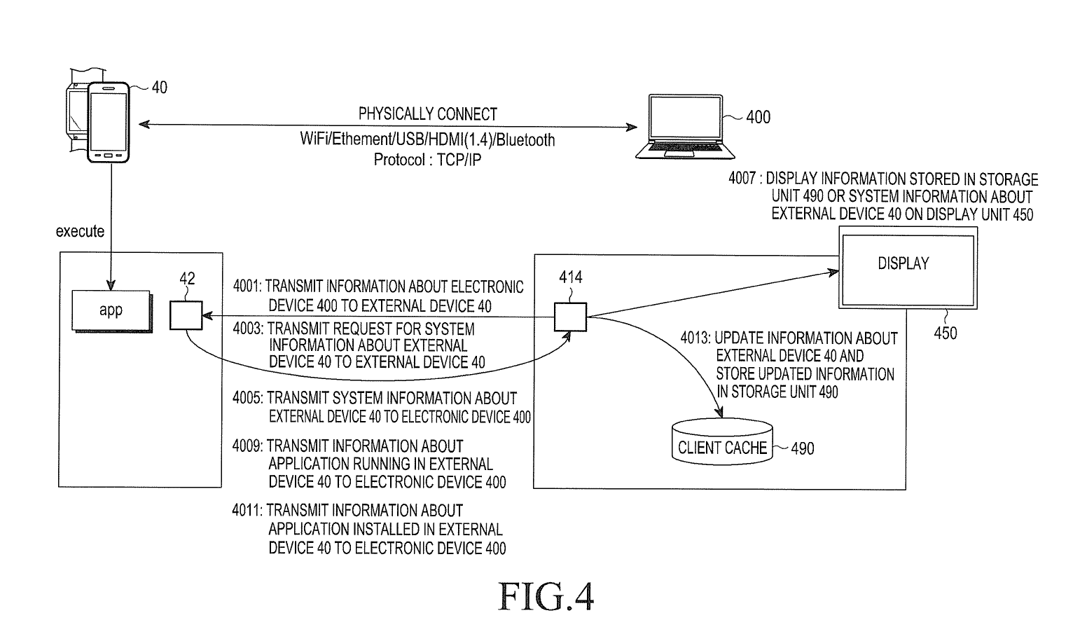

FIG. 4 is a diagram illustrating an operation of exchanging information with an external device by an electronic device according to an exemplary embodiment of the present disclosure. Referring to FIG. 4, a protocol (for example, TCP/IP) can be stored in advance in order to exchange data between an electronic device 400 and an external device 40, and the electronic device 400 and the external device 40 can be connected with each other through, for example, WiFi communication, USB communication, HDMI communication, Ethernet communication, or BLUETOOTH communication.

For convenience of description, FIG. 4 schematically illustrates that a remote device manager 414 of the electronic device 400 transmits and receives information with a docking client 42 of the external device 40, but the electronic device 400 and the external device 40 transmit and receive information through a communication module. Further, in the exemplary embodiment related to FIG. 2, the remote device manager 214 is described as being separated from the application manager 216, but according to the exemplary embodiment of FIG. 4, the application manager 216 is included in the remote device manager 214 and 414 so that the remote device manager 214 and 414 also performs the operation of the application manager 216.

According to one exemplary embodiment, the remote device manager 414 of the electronic device 400 transmits information (for example, information about the remote device manager 414) about the electronic device 400 to the external device 40 through the communication module in operation 4001.

The remote device manager 414 transmits a system information request of the external device 40 to the external device 40 through the communication module in operation 4003. For example, the system information about the external device 40 can variously include, for example, a battery capacity of the external device 40, a memory use amount of the external device 40, and/or the total memory capacity of the external device 40.

The docking client 42 of the external device 40 transmits the system information about the external device 40 to the electronic device 400 through the communication module in operation 4005.

The remote device manager 414 displays information stored in a storage unit 490 of the electronic device 400 or the system information about the external device 40 on a display unit 450 in operation 4007. The information stored in the storage unit 490 of the electronic device 400 can contain information about an application, which is currently running in the external device 40, stored before the aforementioned operations, and/or information about one or more applications installed in the external device 40 before the aforementioned operations.

The docking client 42 of the external device 40 transmits the information about the application, which is currently running in the external device 40, to the electronic device 400 through the communication module in operation 4009. The information about the application, which is currently running in the external device 40, contains identification information about the application or information indicating that the application is currently running in the external device.

The docking client 42 of the external device 40 transmits the information about one or more applications, which are currently installed in the external device 40, to the electronic device 400 through the communication module in operation 4011. The information about one or more installed applications contains identification information about each application.

The remote device manager 414 of the electronic device 400 updates the information about the external device 40 (the system information about the external device 40, the information about the application which is currently running in the external device 40, and/or the information about one or more applications installed in the external device 40), and stores the updated information in the storage unit 490 in operation 4013.

Hereinafter, the description of when the remote device manger 414 transmits and receives information with the external device, the remote device manger 414 transmits and receives information through the communication module will be omitted.

According to an exemplary embodiment, an electronic device includes: a communication module; an input unit for receiving an input of a user; a display unit for displaying an execution image and an operation state of an application program of the electronic device, and a menu state; and a controller for receiving information about one or more applications installed in an external device from the external device connected through the communication module, listing GUIs corresponding to the applications according to the information about the applications and displaying the listed GUIs on the display unit, transmitting a control request for the application to the external device through the communication module according to a user input for the GUI through the input unit, and receiving control command information according to the control request from the external device through the communication module and applying a control command.

When the controller receives the information about the application containing update information about the application through the communication module, the controller may update the information about the application.

When the information about the application contains the information indicating that the application is currently running in the external device, the GUI corresponding to the application, which is currently running in the external device, can be displayed on the display unit in a designated form that is visually discriminated from a GUI corresponding to the application which is not currently running.

The controller transmits a request for identification information about the application and a command list for executing or changing a setting of the application to the external device through the communication module, when the controller receives a corresponding command list for the request for the command list from the external device through the communication module, the controller displays a GUI corresponding to the corresponding command list on the display unit, and when one command included in the command list is selected according to a user input for the GUI corresponding to the corresponding command list through the input unit, the controller transmits the selected command to the external device through the communication module.

The command list includes at least one of an open command for displaying an execution image of the application by executing the application, a close command for ending the display of the execution image of the application by ending the execution of the application, and a command for a size change of the execution image of the application.

The controller transmits the identification information about the application and the command for executing or changing the setting of the application to the external device through the communication module.

When the controller receives a command for executing the application from the external device through the communication module, the controller displays an execution image of the application on the display unit, and when the controller receives a command for changing a setting of the application from the external device through the communication module, the controller applies a change of the setting of the application.

The electronic device further includes a storage unit, and the controller receives system information about the external device from the external device through the communication module, stores the received system information in the storage unit, and displays the system information about the external device on the display unit.

The system information about the external device includes at least one of a battery capacity of the external device, a memory use amount of the external device, and the total memory capacity of the external device.

When the controller receives the system information about the external device containing update information about the external device through the communication module, the controller updates the system information about the external device according to the update information about the external device.

The information about the application and the control request for the application can be data in an XML form.

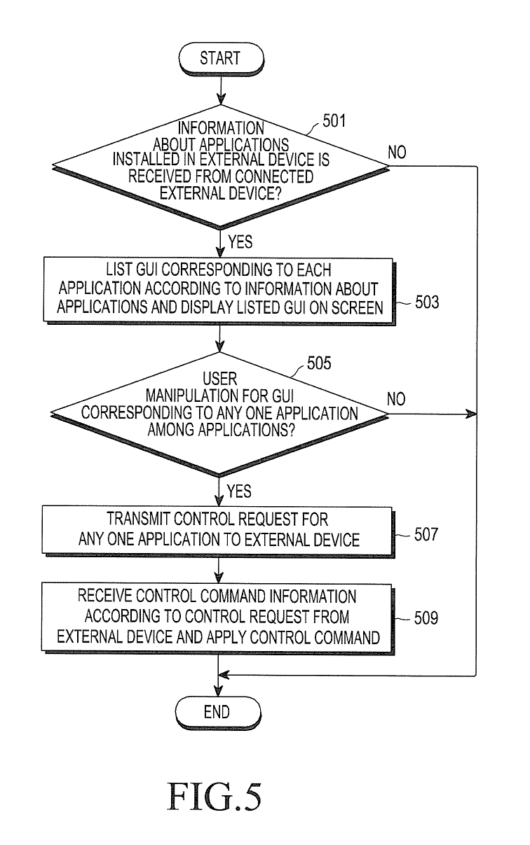

FIG. 5 is a flowchart illustrating an operation of exchanging information with an external device by an electronic device according to an exemplary embodiment of the present disclosure. Referring to FIG. 5, the electronic device receives information about one or more applications installed in the external device from the connected external device, list GUIs corresponding to the applications according to the information about the applications and displays the listed GUIs on a screen, transmits a control request for an application to the external device according to a user manipulation for the GUI, and receives control command information according to the control request from the external device and apply a control command.

The electronic device determines whether information about applications installed in the external device is received from the connected external device in operation 501. When it is determined that the information about the applications installed in the external device is received from the connected external device in operation 501, the electronic device performs operation 503, and when it is determined that the information about the applications installed in the external device is not received from the connected external device in operation 501, the electronic device terminates the operation of the present disclosure. The information about the applications may contain, for example, identification information about each application. Further, the information about the applications may contain, for example, information about one or more applications containing information indicating that the application is currently running in the external device.

The electronic device can list the corresponding GUIs for each application according to the information about the applications and display the listed GUIs on the screen in operation 503. For example, when the information about a specific application contains information indicating that the specific application is currently running in the external device, a GUI corresponding to the application, which is currently running in the external device, can be displayed in a designated form visually discriminated from a GUI corresponding to an application that is not currently running in the external device.

The electronic device determines whether a user manipulation for the GUI corresponding to any one application among the applications is input in operation 505. When it is determined that the user manipulation for the GUI corresponding to any one application among the applications is input in operation 505, the electronic device executes operation 507, and when it is determined that the user manipulation for the GUI corresponding to any one application among the applications is not input in operation 505, the electronic device terminates the operation of the present disclosure. For example, the user manipulation for the GUI corresponding to the application can be, for example, a touch input or a voice input, and executes the application in the electronic device, and can be designated when the electronic device is manufactured or according to a user manipulation.

The electronic device transmits a control request for the application to the external device in operation 507. For example, the transmitting of the control request to the external device includes transmitting the identification information about the application, or a command for executing or changing a setting of the application to the external device. Further, for example, the transmitting of the control request to the external device includes transmitting a request for the identification information about the application or a command list for executing or changing the setting of the application to the external device, displaying a GUI corresponding to a corresponding command list on the screen when the corresponding command list for the request for the command list is received from the external device, and transmitting a selected command to the external device when one command included in the command list is selected according to a user manipulation for the GUI corresponding to the corresponding command list. For example, the command list can variously include an open command for displaying an execution image of the application by executing the application, a close command for ending the display of the execution image of the application by ending the execution of the application, a command for a size change of the execution image of the application, and the like.

The electronic device receives control command information according to the control request from the external device and applies a control command in operation 509. For example, when the electronic device receives a command for executing the application from the external device, the electronic device displays the execution image of the application. Further, for example, when the electronic device receives a command for changing the setting of the application from the external device, the electronic device applies the change of the setting of the application. Further, for example, when the electronic device receives update information about one or more applications installed in the external device, the electronic device updates information about the corresponding application.

The electronic device according to the exemplary embodiment of the present disclosure receives and stores system information about an external device, and display the system information about the external device on the screen. Further, the electronic device receives the system information about the external device containing update information about the external device. Further, when the electronic device receives the system information about the external device containing update information about the external device, the electronic device updates the system information about the external device according to the update information about the external device. The system information about the external device includes at least one of a battery capacity of the external device, a memory use amount of the external device, and the total memory capacity of the external device.

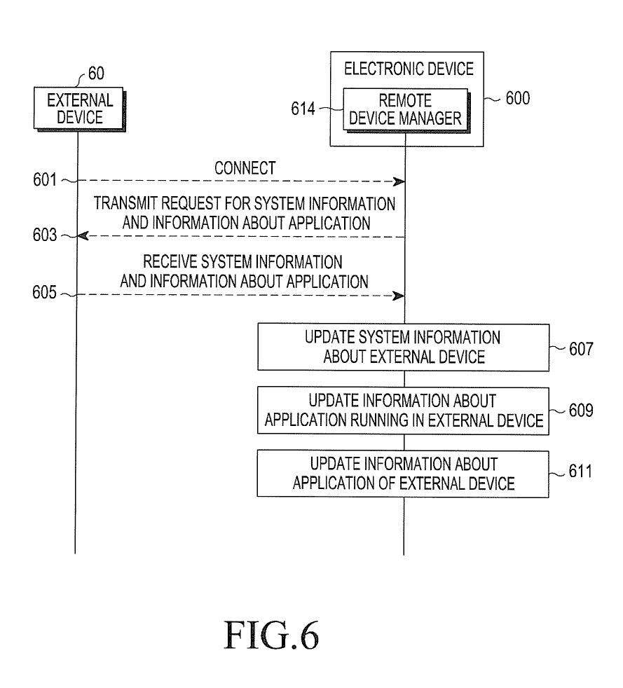

FIG. 6 is a flowchart illustrating an operation of acquiring and updating information about an external device by an electronic device according to an exemplary embodiment of the present disclosure. Referring to FIG. 6, when an electronic device 600 is connected to an external device 60, a remote device manager 614 of the electronic device 600 requests, acquires, and updates information about the external device 60.

When the external device 60 is connected to the electronic device 600 in operation 601, the remote device manager 614 of the electronic device 600 transmits a request for system information about the external device 60 or application information to the external device 60 in operation 603. The system information about the external device 60 can be various, for example, a battery capacity of the external device 60, a memory use amount of the external device 60, and/or the total memory capacity of the external device 60. Further, the application information of the external device 60 can variously include list information about all of the applications installed in the external device 60, list information about the predetermined number of applications having a high use frequency according to an application use frequency of a user of the external device 60, and/or information about an application that is currently running in the external device 60.

The remote device manager 614 receives the system information or the application information of the external device 60 from the external device 60 in operation 605.

The remote device manager 614 updates the system information about the external device 60 in the electronic device 600 in operation 607.

When information indicating that the application is currently running in the external device 60 is contained in the application information, the remote device manager 614 updates information about the application, which is currently running in the external device 60, in the electronic device 600 in operation 609.

The remote device manager 614 updates the application information of the external device 60 in the electronic device 600 in operation 611.

In the meantime, a request or a response between the electronic device 600 and the external device 60 can be asynchronously operated.

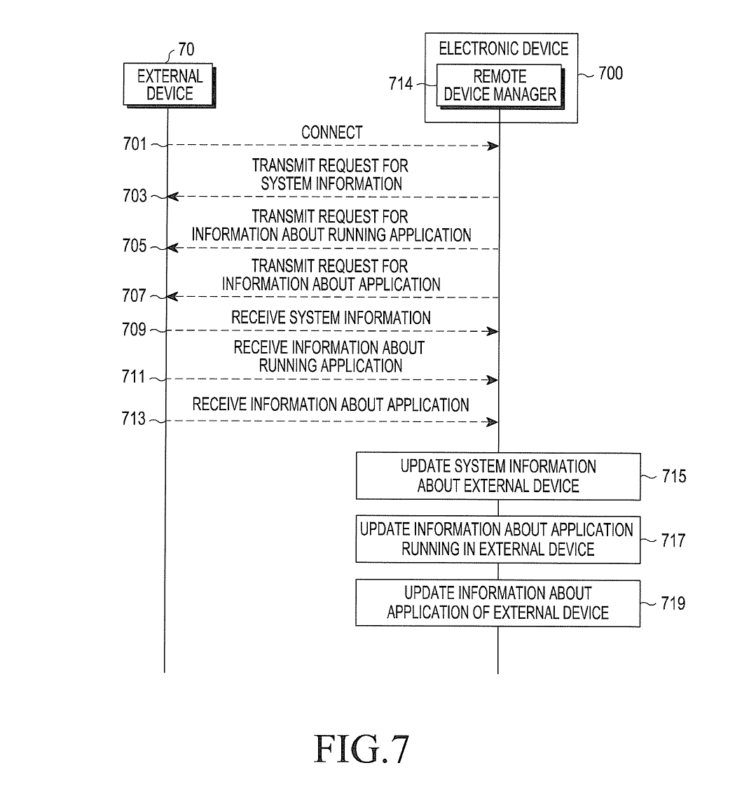

FIG. 7 is a flowchart illustrating an operation of acquiring and updating information about an external device by an electronic device according to another exemplary embodiment of the present disclosure. Referring to FIG. 7, when an electronic device 700 is connected to an external device 70, a remote device manager 714 of the electronic device 700 requests and acquires information about the external device 70 from the external device 70, and updates the acquired information.

When the external device 70 is connected to the electronic device 700 in operation 701, the remote device manager 714 of the electronic device 700 transmits a request for system information about the external device 70 to the external device 70 in operation 703. The remote device manager 714 transmits a request for information about an application, which is currently running in the external device 70, to the external device 70 in operation 705. The remote device manager 714 transmits a request for the information about the application of the external device 70 to the external device 70 in operation 707.

The remote device manager 714 receives the system information about the external device 70 from the external device 70 in operation 709. The remote device manager 714 receives the information about the application, which is currently running in the external device 70, from the external device 70 in operation 711. The remote device manager 714 receives the information about the application of the external device 70 from the external device 70 in operation 713.

The remote device manager 714 updates the system information about the external device 70 in the electronic device 700 in operation 715. The remote device manager 714 updates the information about the application, which is currently running in the external device 70, in the electronic device 700 in operation 717. The remote device manager 714 updates the information about the application of the external device 70 in the electronic device 700 in operation 719.

In the meantime, a request or a response between the electronic device 700 and the external device 70 can be asynchronously operated.

Further, one or more wearable devices can be connected, for example, paired, to the external device 70 connected with the electronic device 700, and the electronic device 700 receives information about a wearable device connected with the external device 70 from the external device 70, and displays corresponding information on a display unit of the electronic device 700.

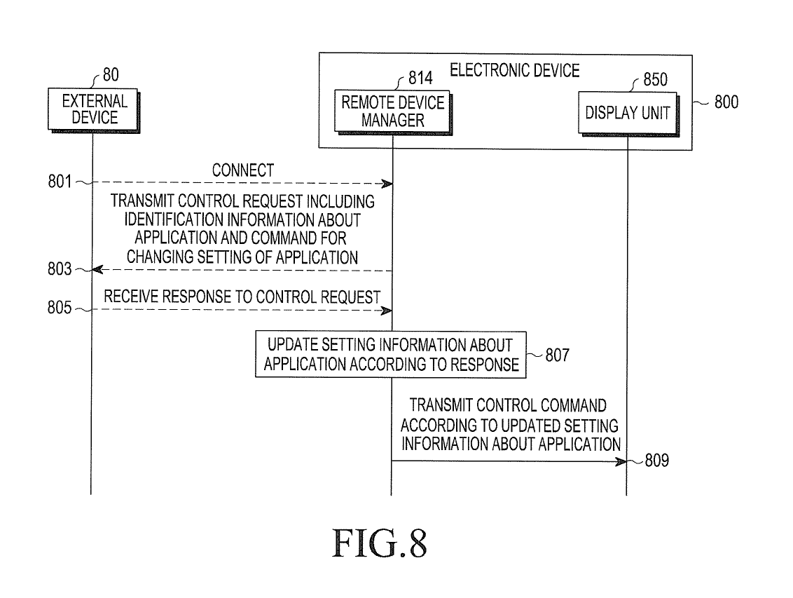

FIG. 8 is a flowchart illustrating an operation of exchanging information with an external device by an electronic device in order to change a setting of an application in the electronic device according to an exemplary embodiment of the present disclosure. Referring to FIG. 8, when an external device 80 is connected to an electronic device 800, the electronic device 800 executes and/or changes a setting of a specific application by transmitting, by the electronic device 800, a request for executing and/or changing a setting of the specific application to the external device 80.

When the external device 80 is connected to the electronic device 800 in operation 801, a remote device manager 814 of the electronic device 800 transmits a control request containing identification information about an application or a command for changing a setting of the application to the external device 80 in operation 803. For example, the command for changing the setting can variously include a command for a size change of an execution image of the application, a command for a font change for changing a shape, a size, and the like of a character of the application, and a deletion command for deleting the application in the external device 80 or the electronic device 800.

The remote device manager 814 receives a response to the control request from the external device 80 in operation 805.

The remote device manager 814 updates setting information about the application according to the response in operation 807.

The remote device manager 814 transmits control information according to the updated setting information about the application to a display unit 850 of the electronic device 800 in operation 809.

In the meantime, a request or a response between the electronic device 800 and the external device 80 can be asynchronously operated.

According to the exemplary embodiment of FIG. 8, when the electronic device 800 transmits a control request containing, for example, a command for changing a size of an execution image of an application to the external device 80 according to a user manipulation, the external device 80 transmits a response to the command, that is, a command for a size change of the execution image of the application, to the electronic device 800. According to the command for the size change of the execution image of the application, the electronic device 800 updates the setting information about the application. Otherwise, when the electronic device 800 displays the execution image of the application on the display unit 850 according to a user manipulation, the electronic device 800 displays the execution image, of which a size is changed, according to the updated setting information.

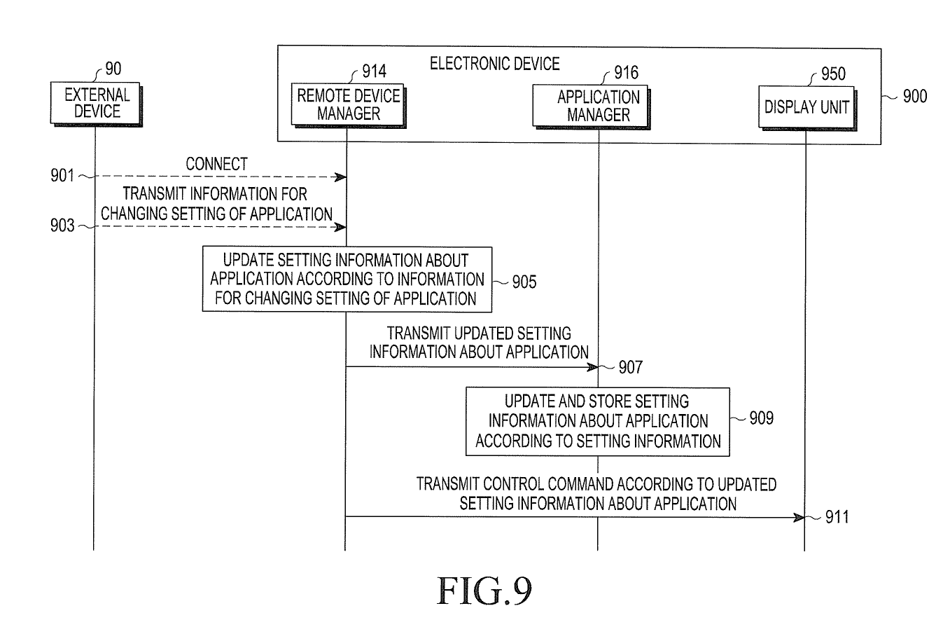

FIG. 9 is a flowchart illustrating an operation of exchanging information with an external device by an electronic device in order to change a setting of an application according to another exemplary embodiment of the present disclosure. Referring to FIG. 9, when an external device 90 is connected to an electronic device 900, and the external device 90 transmits information for updating setting information about a specific application to the electronic device 900, the electronic device 900 updates the setting information about the specific application.

When the external device 90 is connected to the electronic device 900 in operation 901, the external device 90 transmits information for changing a setting of the application to the electronic device 900 in operation 903. For example, the command for changing the setting can variously include size change information about an execution image of the application, font change information for changing a shape, a size, and the like of a character of the application, and a deletion command for deleting the application in the electronic device 900.

A remote device manager of the electronic device 900 updates setting information about the application according to the information for changing the setting in operation 905.

The remote device manager 914 transmits the updated setting information about the application to an application manager 916 of the electronic device 900 in operation 907.

The application manager 916 updates the setting information about the application according to the setting information and stores the updated setting information in operation 909.

The remote device manager 914 transmits a control command according to the updated setting information about the application to a display unit 950 of the electronic device 900 in operation 911.

According to the exemplary embodiment of FIG. 9, when the external device 90 transmits information containing, for example, a deletion command of the application to the electronic device 900 according to a user manipulation, the electronic device 900 deletes the information about the application from the electronic device 900. Further, the electronic device 900 terminates a display of the GUI corresponding to the application.

In the meantime, a request or a response between the electronic device 900 and the external device 90 can be asynchronously operated.

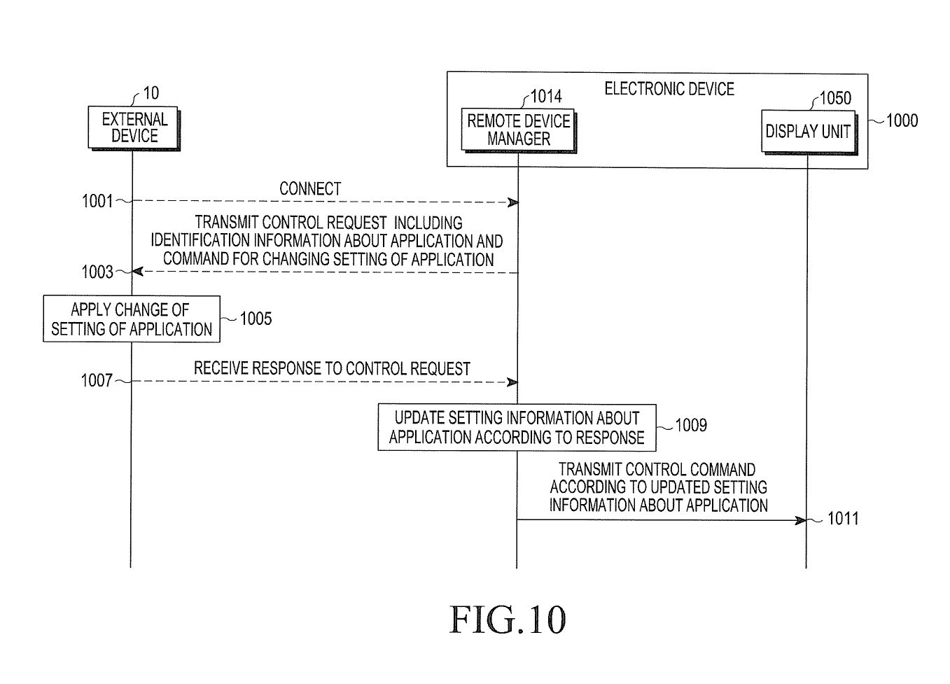

FIG. 10 is a flowchart illustrating an operation of exchanging information with an external device by an electronic device in order to change a setting of an application in an electronic device according to yet another exemplary embodiment of the present disclosure. Referring to FIG. 10, when an external device 10 is connected to an electronic device 1000, the external device 10 or the electronic device 1000 executes and/or changes a setting of a specific application by transmitting a request for executing and/or changing the setting of the specific application to the external device 10 from the electronic device 1000.

When the external device 10 is connected to the electronic device 1000 in operation 1001, a remote device manager 1014 of the electronic device 1000 transmits a control request containing identification information about an application installed in the external device 10 or a command for changing a setting of the application to the external device 10 in operation 1003.

The external device 10 applies a setting change of the application according to the control request in operation 1005.

The remote device manager 1014 receives a response to the control request from the external device 10 in operation 1007.

The remote device manager 1014 updates setting information about the application according to the response in operation 1009.

The remote device manager 1014 transmits a control command according to the updated setting information about the application to a display unit 1050 of the electronic device 1000 in operation 1011.

In the meantime, a request or a response between the electronic device 1000 and the external device 10 can be asynchronously operated.

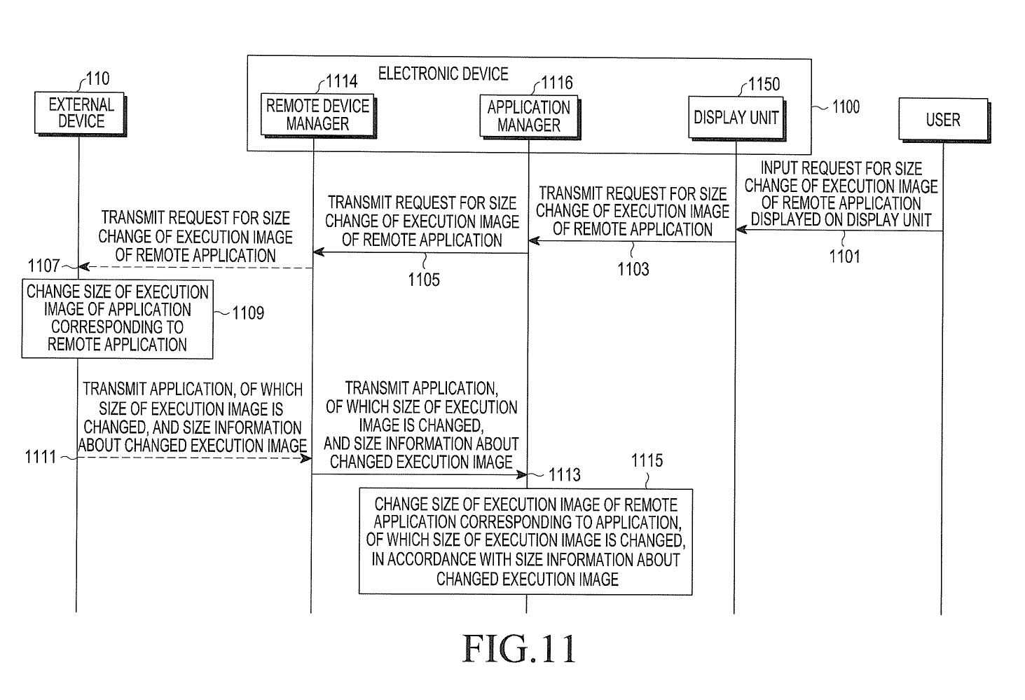

FIG. 11 is a flowchart illustrating an operation of exchanging information with an external device by an electronic device in order to change a setting of an application in the electronic device or the external device according to an exemplary embodiment of the present disclosure, and the operation will be described based on the case where a setting change of the application is a change in a size of an execution image of the application as an example.

When a request for a change in a size of an execution image of any one application (also referred to as “a remote application”) displayed on a display unit 1150 of an electronic device 1100 is input according to a user manipulation in operation 1101, the request for the change in the size of the execution image of the remote application can be transmitted to an application manager 1116 of the electronic device 1100 in operation 1103.

The application manager 1116 transmits the request for the change in the size of the execution image of the remote application to a remote device manager 1114 in operation 1105, and the remote device manager 1114 transmits the request for the change in the size of the execution image of the remote application to an external device 110 connected with the electronic device 1100 in operation 1107.

The external device 110 changes the size of an execution image of an application corresponding to the remote application and stores the application in operation 1109.

The external device 110 transmits information on the application, of which the size of the execution image is changed, or on the changed size of the execution image to the remote device manager 1114 in operation 1111, and the remote device manager 1114 transmits information on the application, of which the size of the execution image is changed, or on the changed size of the execution image to an application manager 1116 in operation 1113.

The application manager 1116 changes the size of the execution image of the remote application corresponding to the application, of which the size of the execution image is changed, in accordance with size information about the changed execution image in operation 1115.

In the meantime, a request or a response between the electronic device 1100 and the external device 110 can be asynchronously operated.

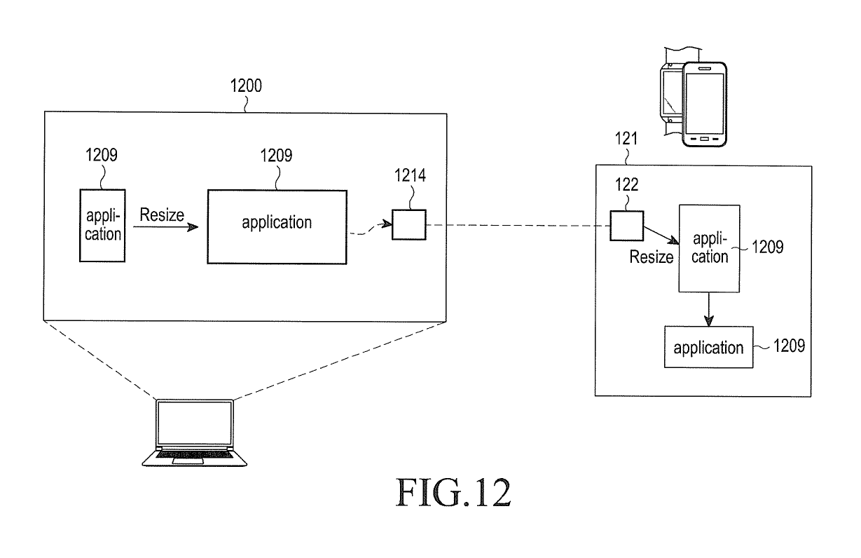

FIG. 12 is a flowchart illustrating an operation of exchanging information with an external device by an electronic device in order to change a setting of an application in the electronic device or the external device according to an exemplary embodiment of the present disclosure, and the operation will be described based on the case where a setting change of the application is a change in a size of an execution image of the application as an example. According to the exemplary embodiment of FIG. 12, a size change command for an execution image of any one application 1209 among the applications of an electronic device 1200 is input, a remote device manager 1214 of the electronic device 1200 transmits a request for a size change command for the execution image of the application 1209 to a docking client 122 of an external device 121. According to the operation, the external device 121 updates size information about the execution image of the application 1209, and displays the execution image, to which the updated size information is applied, on a display unit when the application 1209 is executed.

In the meantime, according to the exemplary embodiment, when the external device 121 is rotated, so that an execution image of an application, which is currently running on the display unit of the external device 121, is rotated and displayed, the external device 121 transmits information indicating that the execution image of the application, which is currently running, is rotated and displayed to the electronic device 1200 connected with the external device 121. When the electronic device 1200 receives the information indicating that the execution image of the application, which is currently running, is rotated and displayed from the external device 121, the electronic device 1200 displays the received information on a display unit of the electronic device 1200.

Further, according to the exemplary embodiment, when the display unit of the electronic device 1200 has sufficient display space for displaying specific information or the execution image, the electronic device 1200 transmits coordinate information about an available area to the external device 121. For example, the electronic device 1200 inserts coordinate information about an available area into an XML and transmits the coordinate information to the external device 121. The external device 121 determines a size of an execution image of any one application by using the coordinate information about the available area transmitted by the electronic device 1200, and transmits the determined size of the execution image to the electronic device 1200. When the electronic device 1200 receiving the deter mined size of the execution image executes a specific application, the electronic device 1200 displays the execution image corresponding to the determined size of the execution image on the display unit.

Further, according to the exemplary embodiment, when the electronic device 1200 fails to display an execution image of a specific application on the display unit of the electronic device 1200 when executing the specific application according to a user manipulation, the electronic device 1200 also displays a designated notification corresponding to the application on the display unit of the electronic device 1200 instead of the execution image of the application.

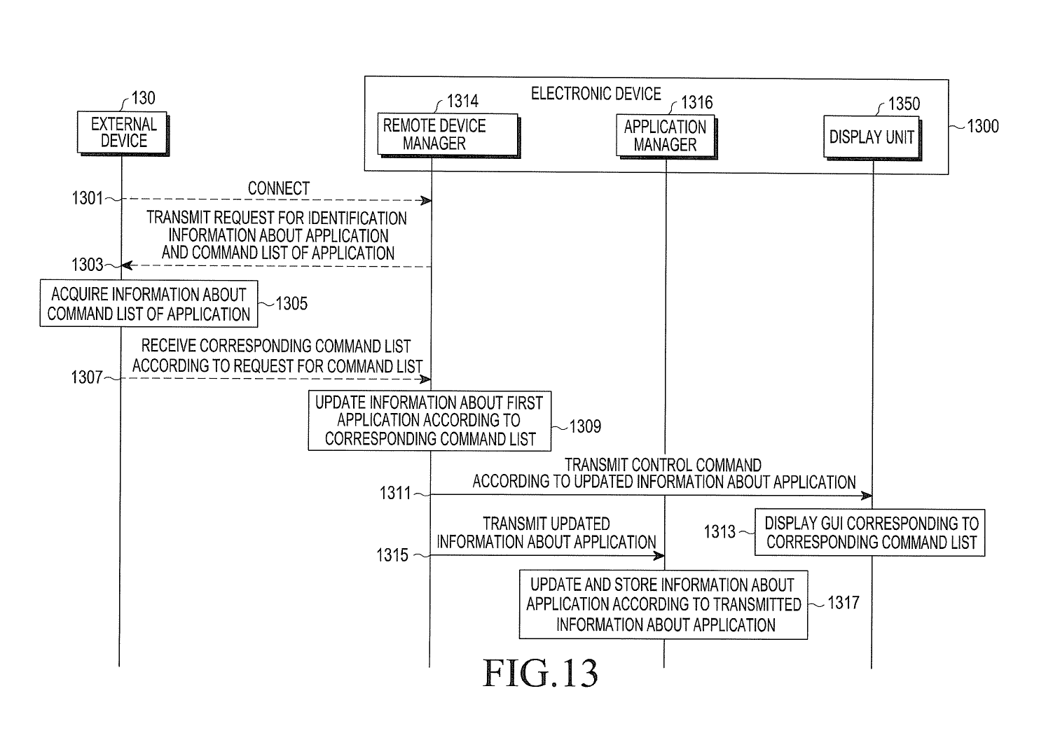

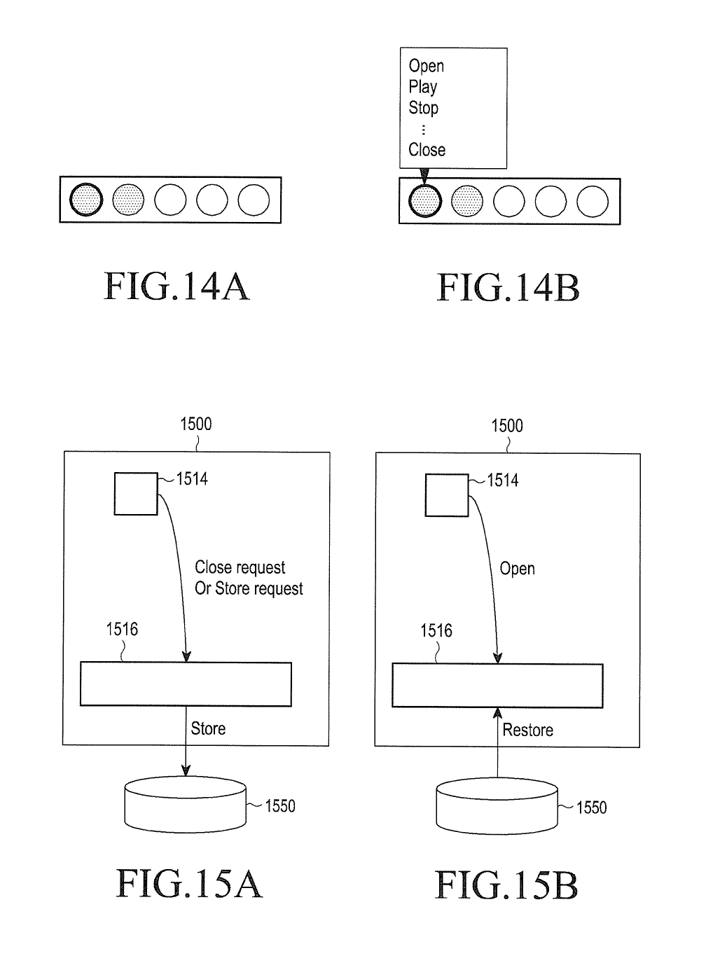

FIG. 13 is a flowchart illustrating an operation of displaying a command list of an application in an electronic device according to an exemplary embodiment of the present disclosure, and FIGS. 14A and 14B are diagrams illustrating graphic user interfaces of applications or a command list of an application according to an exemplary embodiment of the present disclosure. Referring to FIG. 13, an electronic device 1300 transmits a request for identification information about a specific application installed in an external device 130 or a command list for executing or changing a setting of the specific application to the external device 130, and when the electronic device 1300 receives the corresponding command list for the request for the command list from the external device 130, the electronic device 1300 displays a GUI corresponding to the corresponding command list to a screen of the electronic device 1300.

When the external device 130 is connected to the electronic device 1300 in operation 1301, a remote device manager 1314 of the electronic device 1300 transmits the request for the identification information about the application or the command list of the application to the external device 130 in operation 1303.

For example, respective GUIs corresponding to the entirety or a part of the applications among the applications installed in the external device 130 can be listed and displayed as illustrated in FIG. 14A. When a GUI corresponding to any one application among the applications is selected according to a user manipulation, the remote device manager 1314 of the electronic device 1300 transmits the request for the identification information about the application or the command list of the application to the external device 130. For example, the command list can variously include an open command for displaying an execution image of the application by executing the application, a close command for ending the display of the execution image of the application by ending the execution of the application, a command for a size change of the execution image of the application, and the like. Further, the command list includes different commands for each application. For example, a command list of an MP3 application can further include a music play command, a pause command, and the like in addition to the aforementioned commands.

The external device 130 acquires information on a designated command list of the application in operation 1305.

The remote device manager 1314 receives a corresponding command list according to the request for the command list in operation 1307.

The remote device manager 1314 updates the information about the application according to the corresponding command list in operation 1309.

The remote device manager 1314 transmits a control command according to the updated information about the application to a display unit 1350 of the electronic device 1300 in operation 1311.

The display unit 1350 displays a GUI corresponding to a corresponding command list according to the received control command in operation 1313. For example, as illustrated in FIG. 14B, the selected command list of the application, for example, Open, Play, Stop, and Close, can be displayed on a screen in the state where the respective GUIs corresponding to the entirety or a part of the applications among the applications installed in the external device 130 are listed and displayed.

The remote device manager 1314 transmits the updated information about the application to an application manager 1316 of the electronic device 1300 in operation 1315.

The application manager 1316 updates the information about the application according to the received information and store the updated information in operation 1317.

According to an exemplary embodiment, when one command included in the command list is selected according to a user manipulation for the GUI corresponding to the corresponding command list, the electronic device 1300 transmits the selected command to the external device 130, receive a response from the external device 130, and execute the command in the electronic device 1300.

FIGS. 15A and 15B are diagrams illustrating an operation of storing, by an electronic device, information received from an external device and utilizing the stored information according to an exemplary embodiment of the present disclosure. Referring to FIG. 15A, when an electronic device 1500 receives information about an application and/or system information about an external device from the external device, an application manager 1516 stores the information about the application and/or the system information about the external device in a storage unit 1550 according to a control of a remote device manager 1514. Further, referring to FIG. 15B, for example, when a user manipulation for executing a specific application is input, the application manager 1516 executes the specific application by using information about the specific application stored in the storage unit 1550 according to a control of a remote device manager 1514.

According to an exemplary embodiment, a method of exchanging information with an external device includes receiving information about one or more applications installed in the external device from the connected external device, displaying a GUI corresponding to the application on a screen according to the information about the application, transmitting a control request for the application corresponding to a user input for the GUI to the external device, and receiving control command information according to the control request from the external device and applying a control command.

The method of exchanging information with the external device further includes updating the information about the application when the information about the application containing update information about the application is received.

When the information about the application contains the information indicating that the application is currently running in the external device, the GUI corresponding to the application, which is currently running in the external device, can be displayed on a display unit in a designated form that is visually discriminated from a GUI corresponding to the application which is not currently running.

Further, for example, the transmitting of the control request to the external device includes transmitting a request for identification information about the application and a command list for executing or changing a setting of the application to the external device, displaying a GUI corresponding to a corresponding command list on a screen when the corresponding command list for the request for the command list is received from the external device, and transmitting a selected command to the external device when one command included in the command list is selected according to a user input for the GUI corresponding to the corresponding command list.

The command list includes at least one of an open command for displaying an execution image of the application by executing the application, a close command for ending the display of the execution image of the application by ending the execution of the application, and a command for a size change of the execution image of the application.

The transmitting of the control request to the external device includes transmitting the identification information about the application, and a command for executing or changing the setting of the application to the external device.

The applying of the control command includes displaying an execution image of the application when a command for executing the application is received from the external device, and applying a change of the setting of the application when a command for changing the setting of the application is received from the external device.

The method of exchanging information with the external device further includes receiving system information about the external device from the external device and storing the received system information, and displaying the system information about the external device on the screen.

The system information about the external device includes at least one of a battery capacity of the external device, a memory use amount of the external device, and the total memory capacity of the external device.

The method of exchanging information with the external device includes, when the system information about the external device containing update information about the external device is received, updating the system information about the external device according to the update information about the external device.

The information about the application and the control request for the application can be data in an XML form.

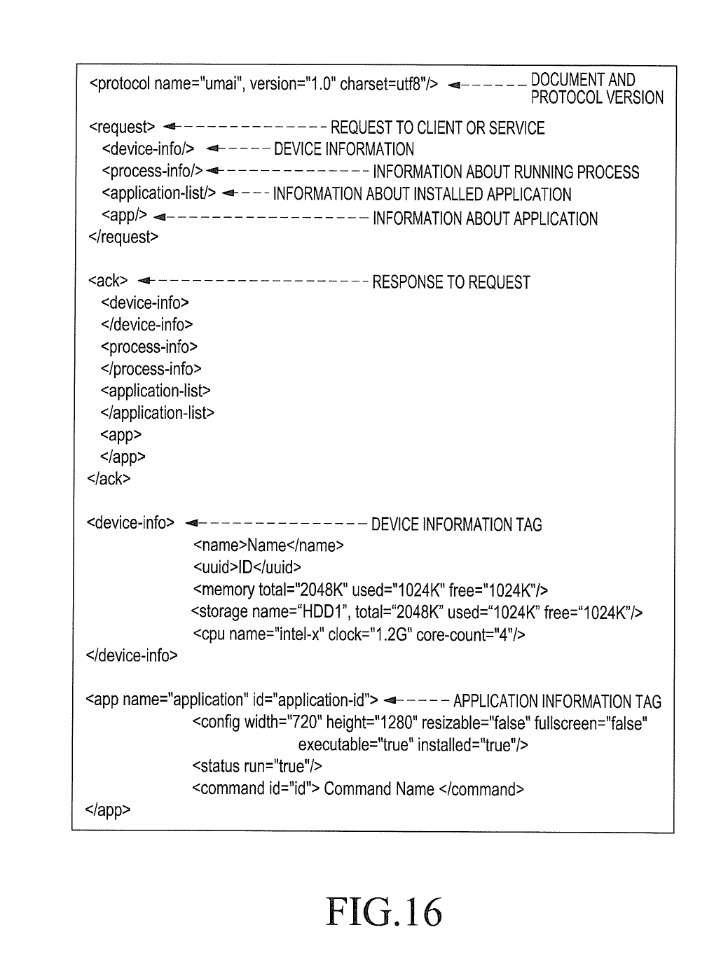

FIG. 16 is a program code for exchanging information with an external device by an electronic device according to an exemplary embodiment of the present disclosure. Referring to FIG. 16, a program code for exchanging information with an external device by an electronic device can have an XML data format. Further, according to the program code, the electronic device requests system information about the external device and information about one or more applications installed in the external device, and receive a response to the request.

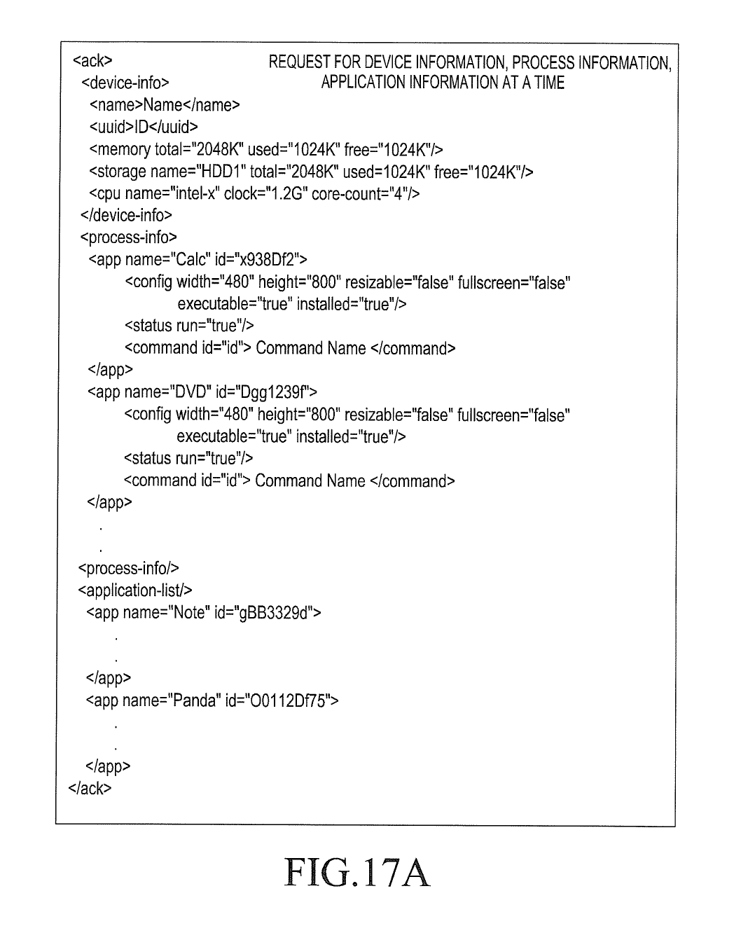

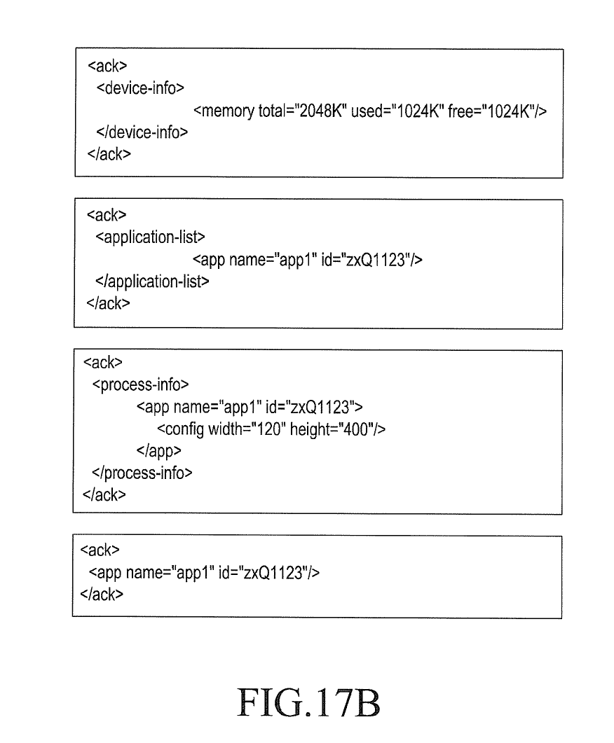

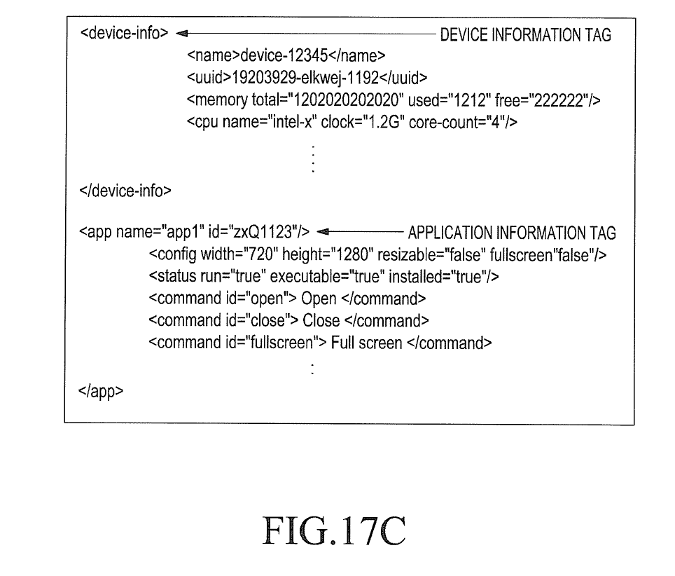

FIGS. 17A to 17C are program codes for exchanging information with an external device by an electronic device according to another exemplary embodiment of the present disclosure. Referring to FIG. 17, a program code for exchanging information with an external device by an electronic device may have an XML data format. Referring to FIG. 17A, an electronic device can collectively request system information about an external device and information about one or more applications installed in the external device from the external device at a time. Further, referring to FIG. 17B, the electronic device can separately receive information in response to the request from the external device. Further, referring to FIG. 17C, information about the electronic device and information about any one application installed in the electronic device can be checked.

According to an exemplary embodiment, it is possible to transmit system information about an external device and information about at least one application installed in the external device from the external device to the electronic device.

Each of the above described elements of the electronic device according to various embodiments of the present disclosure may be formed of one or more components, and the name of a corresponding element can vary according to the type of an electronic device. The electronic device according to various embodiments of the present disclosure can be formed to include at least one of the above described components, and some of the components may be omitted or additional components may be further included. Further, some of the elements of the electronic device according to various embodiments of the present disclosure can be coupled to form a single entity while performing the same functions as those of the corresponding elements before the coupling.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure may include at least one of an application-specific integrated circuit (ASIC) chip, a field-programmable gate array (FPGA), and a programmable-logic device for performing certain operations, which are now known or will be developed in the future.

At least some of the devices (e.g., modules or functions thereof) or methods (e.g., operations) according to various embodiments of the present disclosure may be implemented by, for example, by a command stored in a computer-readable storage medium in the form of a programming module. When the command is executed by one or more processors, the one or more processors may perform a function corresponding to the command. The computer-readable storage medium may be, for example, the memory 260. At least some of the programming modules may be implemented (for example, executed) by, for example, the processor. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. Any of the hardware devices as described above may be configured to work as one or more software modules in order to perform the operations according to various embodiments of the present disclosure, and vice versa.

Although the present disclosure has been described with an exemplary embodiment, various changes and modifications may be suggested to one skilled in the art. It is intended that the present disclosure encompass such changes and modifications as fall within the scope of the appended claims.

It will be appreciated that the exemplary embodiments of the present disclosure may be implemented in a form of hardware, software, a combination of hardware and software. Regardless of being erasable or re-recordable, such an optional software may be stored in a nonvolatile storage device such as a ROM, a memory such as an RAM, a memory chip, a memory device, or an integrated circuit, or a storage medium such as a CD, a DVD, a magnetic disc, or a magnetic tape that is optically or electromagnetically recordable and readable by a machine, for example, a computer. It is appreciated that the storage unit included in the electronic device is one example of the machine-readable storage media suitable for storing a program or programs including commands for implementing various embodiments of the present disclosure. Accordingly, the present disclosure includes a program that includes a code for implementing an apparatus or a method defined in any claim in the present specification and a machine-readable storage medium that stores such a program. Further, the program may be electronically transferred by a predetermined medium such as a communication signal transferred through a wired or wireless connection, and the present disclosure appropriately includes equivalents of the program.

What is claimed is:

1. A method of exchanging information with an external device, comprising:
receiving information about one or more applications installed in the external device from the connected external device;
displaying a Graphic User Interface (GUI) corresponding to the application on a screen according to the information about the application;
transmitting a control request for the application corresponding to a user input for the GUI to the external device; and
receiving control command information according to the control request from the external device and applying a control command.

2. The method of claim 1, further comprising:
updating the information about the application when the information about the application containing update information about the application is received.

3. The method of claim 1, wherein when the information about the application contains information indicating that the application is currently running in the external device, the GUI corresponding to the application, which is currently running in the external device, is displayed in a designated form visually discriminated from a GUI corresponding to an application, which is not currently running.

4. The method of claim 1, wherein the transmitting of the control request to the external device includes:
transmitting a request for identification information about the application and a command list for executing or changing a setting of the application to the external device;
when the corresponding command list for the request for the command list is received from the external device, displaying a GUI corresponding to the corresponding command list on the screen; and
when one command included in the command list is selected according to a user input for the GUI corresponding to the corresponding command list, transmitting the selected command to the external device.

5. The method of claim 4, wherein the command list includes at least one of an open command for displaying an execution image of the application by executing the application, a close command for ending a display of the execution image of the application by ending the execution of the application, and a command for a size change of the execution image of the application.

6. The method of claim 1, wherein the transmitting of the control request to the external device includes transmitting identification information about the application and a command for executing or changing a setting of the application to the external device.

7. The method of claim 6, wherein the applying of the control command includes:
displaying an execution image of the application when a command for executing the application is received from the external device; and
applying a setting change of the application when the command for changing the setting of the application is received from the external device.

8. The method of claim 1, further comprising:
receiving system information about the external device from the external device and storing the received system information; and
displaying the system information about the external device on the screen.

9. The method of claim 8, wherein the system information about the external device includes at least one of a battery capacity of the external device, a memory use amount of the external device, and a total memory capacity of the external device.

10. The method of claim 8, further comprising:
updating the system information about the external device according to the update information about the external device when the system information about the external device containing the update information about the external device is received.

11. The method of claim 1, wherein the information about the application and the control request for the application is data in an Extensible Markup Language (XML) form.

12. An electronic device, comprising:
a communication module;
an input unit configured to receive an input of a user;
a display unit configured to display an execution image and an operation state of an application program of the electronic device, and a menu state; and
a controller configured to:
receive information about one or more applications installed in an external device from the external device connected through the communication module,
list a GUI corresponding to the application according to the information about the application,
display the listed GUI on the display unit,
transmit a control request for the application to the external device through the communication module according to a user input for the GUI through the input unit, and
receive control command information according to the control request from the external device through the communication module and apply a control command.

13. The electronic device of claim 12, wherein when the controller receives the information about the application containing update information about the application through the communication module, the controller updates the information about the application.

14. The electronic device of claim 12, wherein when the information about the application contains information indicating that the application is currently running in the external device, the GUI corresponding to the application, which is currently running in the external device, is displayed on the display unit in a designated form visually discriminated from a GUI corresponding to an application, which is not currently running.

15. The electronic device of claim 12, wherein the controller is configured to transmit a request for identification information about the application and a command list for executing or changing a setting of the application to the external device through the communication module, when the controller receives a corresponding command list for the request for the command list from the external device through the communication module, the controller displays a GUI corresponding to the corresponding command list on the display unit, and when one command included in the command list is selected according to a user input for the GUI corresponding to the corresponding command list through the input unit, the controller transmits the selected command to the external device through the communication module.

16. The electronic device of claim 15, wherein the command list includes at least one of an open command for displaying an execution image of the application by executing the application, a close command for ending a display of the execution image of the application by ending the execution of the application, and a command for a size change of the execution image of the application.

17. The electronic device of claim 12, wherein the controller is configured to transmit identification information about the application and a command for executing or changing a setting of the application to the external device through the communication module.

18. The electronic device of claim 17, wherein when the controller receives a command for executing the application from the external device through the communication module, the controller displays an execution image of the application on the display unit, and when the controller receives a command for changing a setting of the application from the external device through the communication module, the controller applies a change of the setting of the application.

19. The electronic device of claim 12, further comprising:
a storage unit,
wherein the controller is configured to receive system information about the external device from the external device through the communication module and store the received system information in the storage unit, and displaying the system information about the external device on the display unit.

20. The electronic device of claim 19, wherein the system information about the external device includes at least one of a battery capacity of the external device, a memory use amount of the external device, and a total memory capacity of the external device.

21. The electronic device of claim 19, wherein when the controller receives the system information about the external device containing update information about the external device through the communication module, the controller updates the system information about the external device according to the update information about the external device.

22. The electronic device of claim 12, wherein the information about the application and the control request for the application is data in an XML form.
